(19) United States
(12) Patent Application Publication
(10) Pub. No.: US 2026/0105465 A1
(43) Pub. Date: Apr. 16, 2026

(54) SYSTEMS AND METHODS FOR Al ENABLED GENERATION OF REGULATORY ARTIFACTS

(71) Applicant: QMB Inc., Boston, MA (US)

(72) Inventors: Michel Moravia, Norwood, MA (US); Julian Weinstock, Newton, MA (US); Leonard Glatkowski, Columbia, TN (US); Christopher Wallace, Lincoln, RI (US)

(73) Assignee: QMB Inc., Boston, MA (US)

(21) Appl. No.: 19/356,049

(22) Filed: Oct. 11, 2025

Related U.S. Application Data
(60) Provisional application No. 63/706,578, filed on Oct. 11, 2024.

(51) Int. Cl. G06Q 30/018; G06N 5/022

(52) U.S. Cl. CPC G06Q 30/018; G06N 5/022

(57) ABSTRACT

Systems and methods for generating regulatory artifacts are disclosed. A method includes receiving a product information in human-readable text from a user device and identifying one or more classification details based on the product information by a classification module. The method further includes determining, by a regulatory recommendation module, a regulatory pathway based on the classification and a knowledge base, the knowledge base comprising interrelated regulatory data. Further, the method further includes generating, by a contextual data generation module, a contextual data for regulatory requirements from the knowledge base based on the regulatory pathway. The method further includes generating, by one or more agent components, one or more artifacts for requirements of the regulatory pathway using the contextual data.

### CROSS REFERENCE TO PRIOR APPLICATION

This application claims the benefit of U.S. Provisional Patent Application No. 63/706,578, entitled as “SYSTEMS AND METHODS FOR AI ENABLED GENERATION OF REGULATORY ARTIFACTS”, filed Oct. 11, 2024, which is incorporated by reference in its entirety.

### FIELD OF THE INVENTION

This disclosure relates to regulatory compliance automation, product submission, large language models, and artificial intelligence, including agentic AI.

### BACKGROUND

Product designers, developers, and engineers are often confronted with stringent regulations imposed by global authorities. These regulations necessitate comprehensive documentation of all aspects of a product's design and development.

Medical device designers, developers, and engineers face stringent and evolving regulatory requirements from global regulatory authorities such as the U.S. Food and Drug Administration (FDA), European Medicines Agency (EMA), Health Canada, and others in addition to harmonized international standards such as International Organization for Standardization (ISO). These regulations and standards define or mandate the creation of detailed artifacts to document all aspects of a product's design and development, including design inputs, verification processes, risk assessments, and validation testing. The detailed artifacts may be documents, and the documents must follow the voluminous established processes and standards from the various regulatory authorities.

Generating regulatory documents has become increasingly complex over time. The process requires ever-increasing personnel hours, often of highly specialized individuals, which adds significant cost. The preparation of regulatory documents often requires conferring with external entities, libraries, or databases, which consumes additional time. The process has become so time-consuming and expensive that it is impractical for many companies and prohibitively costly for others.

For medical devices, generating regulatory documents presents additional difficulties. An entity developing a medical device must determine the regulatory category that applies to the device. The entity must identify the history of similar medical devices and assess whether any predicate devices or reference devices exist. The entity must then prepare documents that follow the regulations specific to that category of medical device. In some cases, the regulations are limited, but in many cases, the regulations are numerous and highly detailed. The complexity depends on the type of medical device and on the intended use of the device. There is no simple way for the entity to determine whether the regulatory submission is complete or whether critical information is missing. There is also no simple way to know the exact format that the regulatory documents must incorporate.

Further changes to a medical device may require changes to the regulatory documents. For instance, an impact analysis may be required for changes to a device. The regulatory documents are already costly to produce. A modification to the product becomes expensive not because of the engineering change itself, but because of the need to update the regulatory documentation.

Current methods for generating regulatory documents are time-consuming, prone to errors, and unable to keep pace with the rapidly changing regulatory landscape. Despite the advancements in technology, there is still a need for improved techniques to automate the generation of regulatory documents. There is a need in the art for ongoing research and development in this field.

### SUMMARY

This disclosed subject matter seeks to resolve the above-named challenges by introducing an AI-based solution that employs Generative AI (GAI) and Machine Learning (ML) methods to generate suggested regulatory submission documents. For example, the usage of agentic AI, which may be configured to perform specific tasks in a sequence, is significantly faster than the contemporary processes.

Regulations will vary based on the jurisdiction of the region. Accordingly, the region or commercial market for a product or service may require unique artifacts or other regulatory documentation for various products and services. The current disclosure is optimized for the generation of tailored regulatory documents for specific medical device categories and integrates the continuously evolving regulatory updates of global markets. It has the advanced capabilities necessary to interpret complex regulatory language and generate human-readable, compliant documentation. It leverages advanced Artificial Intelligence (AI) models, domain specific knowledge base, and Natural Language Processing (NLP) to interpret the relationships between regulatory statutes, guidelines, testing protocols, and device specifications to provide highly accurate regulatory submission artifacts.

The disclosed subject matter provides an end-to-end AI-native solution for the automated generation of recommended regulatory compliance artifacts for medical devices. An example workflow is to receive device information, classify the device information, determine a regulatory pathway, identify substantial equivalence, generate contextual data, generate artifacts via multi-agent coordination, review the workflow via an expert in the loop feedback loop, and continuously update the process using a traceability analysis. The multiple agents may be orchestrated to act in a sequence in various embodiments. An agent may be configured to orchestrate other agents to produce the regulatory artifacts.

The process may leverage advanced GAI, ML, and Natural Language Processing and Generation (NLP/NLG) models. The system continuously scans for regulatory updates and real-world evidence, ensuring real-time compliance. Expert-in-the-Loop reinforcement learning refines the AI models' outputs, ensuring high precision and accuracy in regulatory documentation.

### BRIEF DESCRIPTION OF THE DRAWINGS

FIG. 1 is a schematic illustrating the main components of an embodiment of a system for generating a regulatory pathway and artifacts.

FIG. 2 is another illustration of the system for generating regulatory artifacts.

FIG. 3 is an illustration of how the system may create a knowledge base.

FIG. 4A is a schematic illustrating an embodiment of the components of the regulatory artifact generation system.

FIG. 4B is a schematic of an embodiment of an agent component.

FIG. 4C is a schematic showing multiple agent components connected in sequence.

FIG. 5 is a flow diagram of a process for generating regulatory artifacts.

FIG. 6 is a screenshot illustrating product information provided by the user in an embodiment of the disclosed subject matter.

FIG. 7 is a screenshot illustrating generation of classification details in an embodiment of the disclosed subject matter.

FIGS. 8 and 9 are screenshots illustrating generation of a comparative analysis of a reference product and selected predicate devices in an embodiment of the disclosed subject matter.

FIG. 10 is a screenshot illustrating regulatory artifacts generated by the regulatory artifact generation system.

FIG. 11 is a schematic of a computer system that may implement an embodiment of the disclosed subject matter.

### DETAILED DESCRIPTION

The disclosed subject matter provides an AI-powered system for the automated generation of regulatory compliance documents and artifacts specific to medical devices. By integrating advanced AI techniques, domain specific knowledge base, Real-World Data/Real-World Evidence, and real-time regulatory updates, the system has high accuracy and repeatability with ongoing regulatory compliance in all generated documents. The disclosed subject matter integrates human feedback to AI training and generation to enhance output of regulatory compliance documents and artifacts. The term Real-World Data, as used herein, may refer to data collected from a variety of historical data sources as well as in real time as it is generated. The data may come from government reports, such as those from various agencies, medical records provided by medical facilities, insurance companies, and similar entities. The data may also include patient information generated by medical facilities, medical devices, and related sources. The term Real-World Evidence, as used herein, may refer to data, reports, and other documents related to the analysis, interpretation, and effectiveness of products or services. Real-world evidence may be collected from sources such as government agencies and reports, corporate compliance records, scientific publications, symposia, academic work, and research reports, among others.

The disclosed subject matter addresses many of the challenges described in the background. For instance, the disclosed subject matter may improve the temporary processes of generating regulatory documentation by at least 75%. In various cases, the disclosed system may complete a task that would have taken one or two days and 20 minutes. Similar differences may be seen for longer tasks.

The system automatically identifies similar medical devices and determines whether existing regulatory artifacts are available for comparison. The system further determines an appropriate template for the regulatory artifacts required for a regulatory submission. The system then generates documents appropriate for the device with any of the information provided by the user. Unknown sections may be omitted with a “TODO” comment to direct the user to complete these sections when they're ready or when the information becomes available. For example, marketing claims for the device may be marked with a TODO as the data is not yet available.

Generated templates may be automatically filled with information derived from product data, regulatory classifications, and related sources. The system removes much of the uncertainty in determining whether the correct regulatory pathway and documents have been identified.

The system also supports rapid modification of a product. When a change is made to a product, the system automatically generates updated regulatory artifacts that reflect the modification. The system therefore reduces the burden of making changes to a product by removing the need for a complete manual reconstruction of regulatory documentation. The system enables the entities to adjust, optimize, and update products and services while maintaining compliance with regulatory requirements. The disclosed subject matter reduces the cost and complexity of regulatory compliance and addresses the impracticality of manual document generation.

The AI-powered engine employs a multitude of pre-trained ML models and a transformer-based architecture for NLP and NLG tasks to interpret complex regulatory documents and extract critical compliance-related information. NLG techniques are used to generate human-readable text for regulatory artifacts, ensuring that the generated content is understandable, complete, and compliant with regulatory standards.

The AI pipeline also uses a customized agent component optimized for responsible AI with safety guardrails for a multitude of generative tasks in the process of making regulatory recommendations.

A domain-specific knowledge base retrieves and integrates relevant regulatory data from multiple regulatory and standards sources so that the AI models have access to relevant and up-to-date regulatory information when generating regulatory artifacts.

The system includes a continuous scanning mechanism that monitors real-time regulatory updates from global bodies such as the FDA, EMA, and ISO. The updates may be fed into the knowledge base so that the outputs produced by the agent components remain aligned with the most recent compliance requirements. In addition, as regulations and standards change, the system may scan previously generated regulatory artifacts to determine whether those artifacts remain compliant with the updated requirements. Accordingly, the system may maintain compliance of earlier artifacts as regulatory frameworks evolve.

To achieve the highest level of precision and regulatory accuracy, the system incorporates reinforcement learning through an Expert-in-the-Loop (EITL) mechanism. Regulatory experts review AI-generated regulatory artifacts, providing corrections and feedback on areas where the AI model may lack nuance or fail to fully comply with specific guidelines. This feedback is integrated back into the AI model and the knowledge base, enabling the system to continuously improve and adapt to expert insights.

The system is designed to generate regulatory documentation and associated artifacts across a wide range of medical device categories, from infusion pumps to autoinjectors to AI-enabled SaMD, among many others. By leveraging the domain-specific templates and real-time regulatory data integration through a knowledge base, the system ensures that each artifact is tailored to the specific requirements of the device category, including unique testing protocols, risk management plans, and validation processes. The system may be configured to incorporate Real-World Data and Real-World Evidence to remain up to date and enhance generated output. For example, the system may include a component that regularly retrieves data that is stored in one or more government databases that collect real-world data. The knowledgebase may then incorporate the retrieved data and use it to generate contexts, which are used to generate regulatory artifacts. In embodiments, the system may be configured to continuously update the knowledge base with data that is collected in real time.

In an exemplary embodiment, the system receives product information in human-readable text via a user device. For example, the user may be a product manufacturer, and the user may interact with the system to input details of the product and retrieve automatically generated artifacts for submission to regulatory authorities. In embodiments, the product may be a medical device, and the product information may comprise data that describes the medical device. This data may include the device's description, intended use, indication for use, technical specifications, functionality of the device, and other information related to the device's performance. This data can be entered through a user interface or directly fed into the system from pre-existing databases.

In embodiments, the system identifies one or more classification details associated with the product based on the product information. For example, the classification details of the medical device can be identified using a knowledge base comprising product standards. For instance, the product standards refer to a comprehensive dataset of various medical devices. By analyzing the product standards, the system identifies the classification details, such as a product code, risk classification, predicate devices, substantially equivalent devices or determining non-existence of substantially equivalent devices and other pertinent classification details as defined by the regulatory authorities. The predicate device refers to an existing medical device that has already been approved by the regulatory authority, such as the U.S. Food and Drug Administration (FDA), and is used as a benchmark to compare a new medical device.

In embodiments, the system determines a regulatory pathway based on the classification and the knowledge base. This involves analyzing the identified classification details and querying the knowledge base that comprises interrelated information from various sources, including global regulations from the regulatory authorities, proprietary data from professionals in the medical device field, and data from existing regulatory submissions, clinical trials, and market reports that provide additional context. By analyzing this interrelated information from the knowledge base, the system determines the efficient and compliant regulatory pathway for the medical device, reducing the chances of submission errors or rejections.

In some embodiments, the knowledge base stores the interrelated information represented as a knowledge graph and vector database. The knowledge graph comprises nodes representing global regulatory standards, medical device classifications, expert knowledge, testing protocols, and real-world updates. The knowledge graph further comprises edges that connect each node with one or more other nodes, the edges representing connections or relationships between the nodes.

In embodiments, the system generates a contextual data for regulatory requirements from the knowledge base based on the regulatory pathway. For instance, once the regulatory pathway is determined, the system generates the contextual data that reflects the specific regulatory requirements for the medical device. The contextual data is generated using the knowledge base, which includes updated global regulations and the proprietary data representing medical device expertise knowledge and is customized as per the determined regulatory pathway. By generating the contextual data, the system sets a foundation for creating required regulatory artifacts for the medical device's regulatory submission.

One purpose of the disclosed subject matter is to generate artifacts required by the regulatory pathway using the contextual data. The disclosed subject matter may include a feedback system that incorporates corrections, confirmations, or enhancements from human developers, experts, or similar sources to assess the output of generated artifacts and other regulatory documents. In embodiments, the system may include a feedback loop that continuously updates and maintains generated artifacts at a high level of accuracy and competence. For example, the system may be configured to regularly request feedback from a variety of sources, including identified experts in various fields, developers to assess output quality, as well as user and client feedback. Accordingly, the system may maintain a constant state of audit or regulatory compliance by leveraging a constant feedback loop that assesses and ensures adherence to evolving regulatory requirements. Accordingly, the system may analyze the requirements for the regulatory pathway using one or more agent components and generate one or more artifacts compliant with the regulatory authorities. For instance, the one or more agent components uses natural language processing to process and understand the contextual data and generate the artifacts required for medical device regulatory submission. For example, the artifacts may include design history files, verification and validation documents, documentation of risk analysis and mitigation strategies, and labeling and instructions for use (IFU) documents.

In embodiments, the system improves a performance of the agent components based on feedback responsive to the generated artifacts. For instance, the generated artifacts can be reviewed by regulatory experts. The experts provide feedback on the accuracy and quality of the generated documents, and this feedback can be used to refine processes of the agent components. The inclusion of the experts' feedback trains the agent components to generate documents to be compliant with the regulatory requirements.

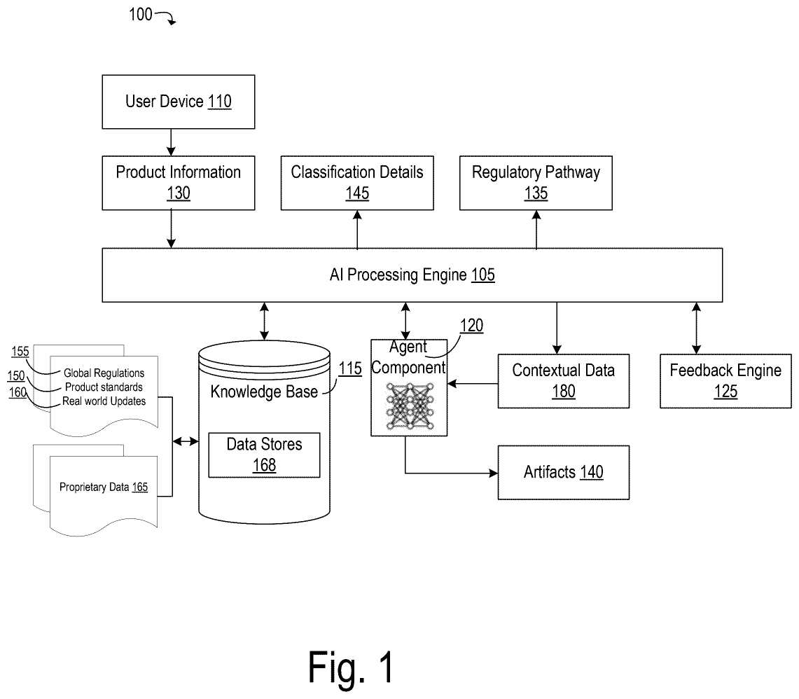

Referring to FIG. 1, FIG. 1 is a schematic illustrating the main components of an embodiment of a system 100 for generating regulatory pathway and artifacts. The embodiment shown in FIG. 1 is one of many possible embodiments. The system 100 comprises an artificial intelligence (AI) processing engine 105, a user device 110, a knowledge base 115, an agent component 120, and a feedback engine 125. In embodiments, the AI processing engine 105 may be integrated with the user device, the agent component 120, the feedback engine 125, and the knowledge base 115 via a network interface or a communication interface.

The AI processing engine 105 is configured to receive a product information 130 from a user in human-readable text via the user device 110. For instance, the user may be a product manufacturer, and the user may input the product information 130 via a user interface of the user device 110. In an embodiment, the product may be a medical device, and the product information 130 may describe the medical device. The AI processing engine 105 is further configured to classify the product based on the product information 130 and generate a regulatory pathway 135 and regulatory artifacts 140 required for the medical device's regulatory submission.

The user device 110 may include, for example, a desktop or laptop computer, tablet, smartphone, wearable devices, medical device interfaces, voice-controlled devices, and the like integrated with the user interface capable of enabling the user to input product information 130 and receive the artifacts 140.

The AI processing engine 105 employs machine learning algorithms to analyze the product information 130 and identify classification details 145. For example, the classification details 145 for the medical device may include a product code, risk classification, predicate devices, and other classification details as defined by the regulatory authorities. The classification details 145 can be identified using product standards 150 stored in the knowledge base 115. The product standards 150 comprise various products' data including medical device classifications, product codes, testing protocols associated with medical devices, and the like.

In embodiments, the AI processing engine 105 may include a traceability function that is capable of identifying a source of a change in regulatory artifacts. For instance, one or more changes, additions, or removals of regulation may result in a modification of one or more regulatory artifacts generated by the disclosed subject matter. The disclosed system may be configured to trace and identify the changes, additions, or removals in regulations that resulted in the modification.

In an example of use, the disclosed system may include a traceability matrix. The traceability matrix may leverage large language models and machine learning techniques to trace any modifications in an output back to modifications in an input. For example, a change in one or more regulatory documents may be processed by the traceability matrix to determine which modifications, if any, to regulations or other regulatory documents led to the changes in the regulatory artifacts.

The knowledge base 115 is a storage device capable of storing global regulations 155, product standards 150, real-world updates 160, and proprietary data 165. The knowledge base may comprise one or more data stores 168, which may include structured, semi-structured, or unstructured repositories. Examples of the data stores 168 include a knowledge graph, a vector database, a relational database, a document database, a key-value store, or a data lake. The knowledge base may also incorporate hybrid arrangements that combine symbolic representations with statistical or embedding-based storage. Embodiments of the knowledge base may employ different types of data stores 168 or hybrid combinations thereof. In one embodiment, the knowledge base 115 may be integrated with the AI processing engine 105. In another embodiment, the knowledge base 115 may be configured as a standalone device independent of the AI processing engine 105.

The agent component 120 is a multi-agent system that is designed to process natural language input and produce natural language output. Each agent in the multi-agent system is configured to work with other agents to produce a desired result. For instance, a task may be passed to a first agent, which produces an output that is passed to a second agent, which produces a second output that is passed to a third agent, and so on. There may be managing or orchestrating agents that are configured to select which agents to assign to a task. In other cases, the managing or orchestrating agent may determine a sequence of agents to process a task.

The agent component 120 can generate output based on an extensive context and can control the type of output that is produced. The agent component 120 can be refined for different purposes, such as interpreting regulations, understanding data stores 168, or creating regulatory artifacts 140. The agent component 120 can also generate questions for a user and interpret the user's answers to refine the context. Different agent components 120 may be configured for different tasks, and multiple agent components 120 may operate together to produce varied outputs. The agent component 120 therefore provides broader capabilities than a large language model by incorporating agency, adaptability, and task-specific refinement.

The agent component 120, integrated into the AI processing engine 105, determines the regulatory pathway 135 based on the classification details 145 and the knowledge base 115. The agent component 120 analyzes the identified classification details 145 and queries the knowledge base 115 which comprises interrelated information from various sources, including the global regulations 155 from the regulatory authorities, the proprietary data 165 from professionals in the medical device field, the real-world updates 160, and the proprietary data 165 from existing regulatory submissions, clinical trials, and market reports that provide additional context. The agent component 120 analyzes this interrelated information using the data stores 168 and determines an efficient and compliant regulatory pathway 135 for the medical device.

In an embodiment where the data stores 168 comprise a knowledge graph and a vector database, the AI processing engine 105 generates a contextual data 180 for regulatory requirements from the knowledge graph and the vector database based on the regulatory pathway 135. The AI processing engine 105 retrieves specific guidelines or submission requirements from the vector database and generates the contextual data 180 that reflects the regulatory requirements for the medical device. The contextual data 180 is customized as per the determined regulatory pathway 135.

The knowledge graph comprises one or more nodes representing the global regulations 155, the product standards 150, the real-world updates 160, and the proprietary data 165. Each node of the knowledge graph is connected with one or more other nodes, representing relationships between the data. The vector database complements the knowledge graph by providing a fast and efficient way to store and retrieve large volumes of unstructured or semi-structured data. The vector database, for example, stores various documents related to the global regulations 155, the product standards 150, the real-world updates 160, and the proprietary data 165 represented as vectors, which are numerical representations of text.

The agent component 120 integrated into the AI processing engine 105, generates artifacts 140 for the requirements of the regulatory pathway 135 using the contextual data 180. The AI processing engine 105 may analyze the requirements for the regulatory pathway using the agent component 120 and generate one or more artifacts 140 compliant with the regulatory pathway 135. For example, the artifacts 140 may include design history files, verification and validation documents, documentation of risk analysis and mitigation strategies, and labeling and instructions for use (IFU) documents.

The agent component 120 receives contextual data 180 from the AI processing engine 105 that is tailored to the specific function of the agent component 120. The AI processing engine 105 may generate different types of contextual data 180 depending on the purpose of the agent component 120. For example, one of the agent component 120 may be configured to generate prompt questions for the user. In this case, the AI processing engine 105 provides contextual data 180 that relates to classification standards so that the agent component 120 can interpret the user's responses and determine a classification of the product or service. The contextual data 180 enables the agent component 120 to produce prompt questions in a targeted way and process user responses accurately.

Another agent component 120 may be configured to generate a template for regulatory artifacts 140 based on the classification. The AI processing engine 105 provides contextual data 180 that contains template structures and requirements that match the identified classification. A further agent component 120 may then be configured to fill in the selected template with information from the user responses and the knowledge base 115. The AI processing engine 105 again provides contextual data 180 specific to this purpose, supplying the information needed to complete the template in a compliant format. In this way, the system 100 applies different contextual data 180 to each agent component 120 depending on the task to be performed.

The described operation of the agent component 120 is only one example. The system 100 may include any number of agent components 120, including a single agent component 120. When multiple agent components 120 are present, they may be configured to work together or to operate independently. Each agent component 120 may be refined for a specific task, or multiple agent components 120 may share responsibility for related tasks.

An example configuration of the system 100 is to combine shared knowledge with task-specific knowledge while maintaining flexibility in how the agent components 120 interact. For instance, the contextual data 180 may vary in scope. Some contextual data 180 may be provided to a single agent component 120 for a specific task. Other contextual data 180 may be shared between multiple agent components 120 so that each component has access to common information. In some cases, the AI processing engine 105 may provide shared contextual data 180 to all relevant agent components 120 and then provide additional contextual data 180 that is reserved for individual agents.

The AI processing engine 105 may select specific contextual data 180 for a given agent component 120 based on the task assigned to that component. The contextual data 180 may be assembled from different sources, such as the knowledge base 115, the product information 130, the classification details 145, or the regulatory pathway 135. The selected contextual data 180 is then provided to the agent component 120 so that the agent component 120 can operate within the proper context.

When the agent component 120 generates an output, the output is returned to the AI processing engine 105. The AI processing engine 105 then determines the next task to be performed and selects another agent component 120 that is suitable for that task. The AI processing engine 105 also determines what contextual data 180 is needed for the next task and provides that contextual data 180 to the selected agent component 120. This sequence can continue across multiple agent components 120, with each component receiving context-specific data and producing outputs.

The AI processing engine 105 manages the flow of contextual data 180 and the sequencing of agent components 120. In some embodiments, the sequence of operations may involve a chain of multiple agent components 120 working in succession. For example, one agent component 120 may interpret a user's responses, another agent component 120 may select an appropriate template, and yet another agent component 120 may fill the template with the required content. Each agent component 120 receives contextual data 180 that is tailored to its assigned task.

The classification details 145 and the artifacts 140 generated by the AI processing engine 105 are sent to the feedback engine 125. The feedback engine 125 enables experts to provide feedback on accuracy and quality of the generated artifacts 140. For example, if the classification details 145 identified by the AI processing engine 105 and/or the artifacts 140 generated by the agent component 120 are not accurate, the feedback is then used to refine the agent component 120 and AI processing engine's 105 processes. This feedback helps the AI processing engine 105 and the agent component 120 to improve their performance and generate documents that are not only compliant but also meet the expectations of the regulatory authorities.

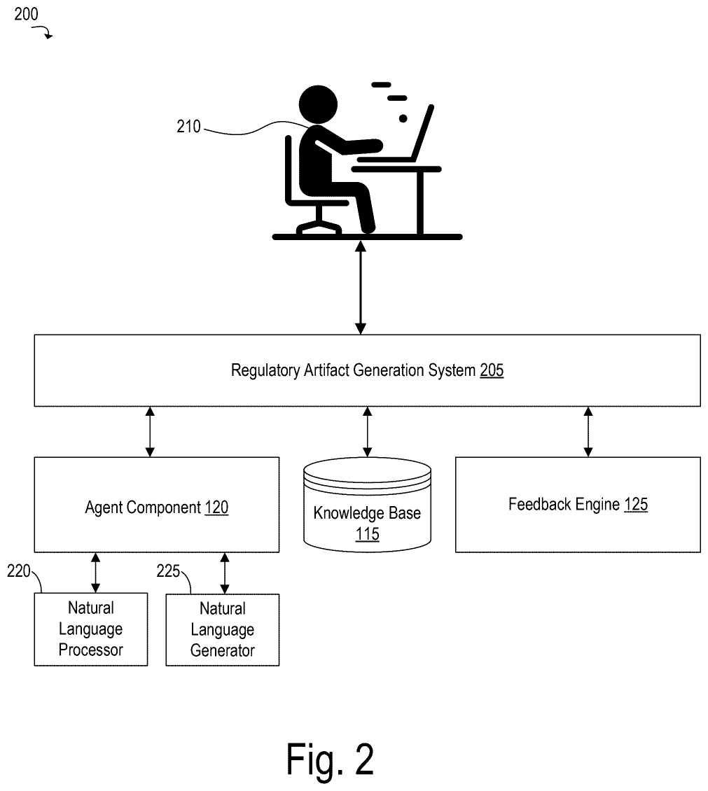

Referring to FIG. 2, FIG. 2 is another illustration of the system 200 for generating regulatory artifacts. The system 200 comprises a regulatory artifact generation system 205, a natural language processor 220, a natural language generator 225, the knowledge base 115, the agent component 120, and the feedback engine 125.

The regulatory artifact generation system 205 interacts with each of the components of the system 200 via a communication network. The regulatory artifact generation system 205 enables a user 210 to input the product information 130 related to a product or a service, for which the regulatory artifact generation system 205 generates one or more artifacts 140 for regulatory submission. For example, the product may be a medical device and the user 210 may provide a description of the medical device as the product information 130. The product information 130 may include a medical device name, functionality of the medical device, and various metadata associated with the medical device.

The regulatory artifact generation system 205 may further prompt the user 210 with one or more questions related to the product. The regulatory artifact generation system 205 records the product information 130 and the user's 210 response to the one or more questions and identifies the classification details 145 associated with the product. The user 210 may provide the response to the one or more questions in natural language. For example, the user 210 may provide the response in text descriptions, documents, or speech. The natural language processor 220 can be used to interpret the user response and extract relevant details for identification of the classification details 145. The regulatory artifact generation system 205 then identifies the classification details 145 using the knowledge base 115 comprising the product standards 150.

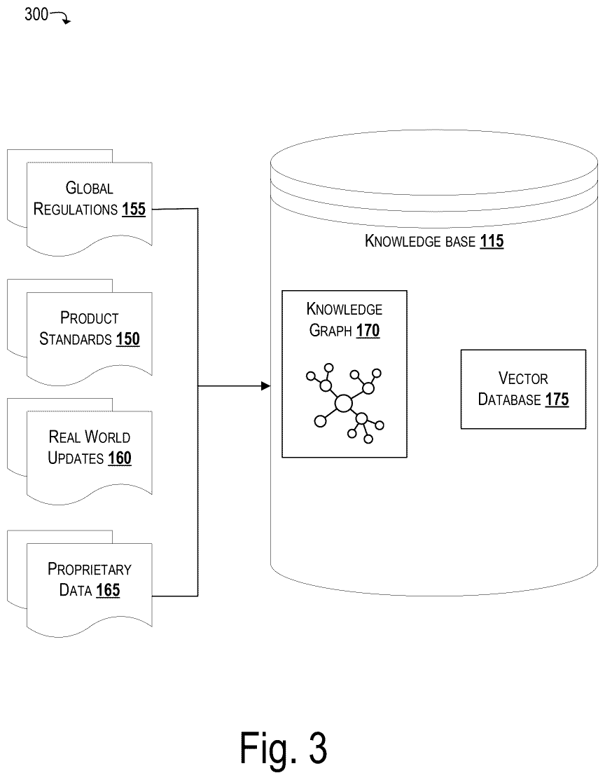

The agent component 120 is integrated to the regulatory artifact generation system 205. In various embodiments, the agent component 120. may generate the regulatory pathway 135 and the artifacts 140 for regulatory submission of the medical device. Variations of the agent component 120 may determine the regulatory pathway 135 based on the classification details 145 and the knowledge base 115 comprising various regulatory standards, medical device expertise knowledge, updated regulations, and the like. The knowledge base 115 stores interrelated data from various sources in the form of the knowledge graph 170 and the vector database 175. The components of the knowledge base 115 are explained in the description of FIG. 3 below.

The regulatory artifact generation system 205 is incorporated with an Artificial Intelligence (AI) technology to generate the contextual data 180 for regulatory requirements. This contextual data 180 can be an input to the agent component 120 for the generation of the artifacts 140. The regulatory artifact generation system 205 retrieves regulatory guidelines, product requirements, and submission requirements from the knowledge base 115 and generates the contextual data 180 that reflects the regulatory requirements for the medical device. The contextual data 180 is customized as per the regulatory pathway 135.

The agent component 120 integrated with the natural language generator 225 generates artifacts 140 for requirements of the regulatory pathway 135 using the contextual data 180. Once the agent component 120 receives the contextual data 180, it uses the natural language generator 225 to draft compliant documents. These documents can include technical summaries, risk assessments, testing protocols, and other forms needed for submission. The agent component 120 generates documentation or artifacts 140 specific to the medical device category, incorporating unique regulatory needs as mandated by the regulatory pathway 135. In this context, the natural language generator 225 refers to an AI-driven process of automatically generating human-readable text from the extensive regulatory data, device-specific requirements, and expert knowledge stored in the knowledge base 115. For example, the natural language generator 225 generates necessary submission documents, including risk assessments and testing protocols, in a manner that regulatory authorities expect and can easily review.

The agent component 120 may accept input and generate output for one or more aspects of a regulatory submission. In the embodiment shown in FIG. 2, the regulatory artifact generation system 205 may pull contextual data from the knowledge base 115 and provide it to one or more agent components 120. The agent component 120 may then generate one or more outputs for a regulatory artifact 140.

The agent component 120 may include a natural language processor 220 and a natural language generator 225. The natural language processor 220 may process contextual data to understand a task and may generate portions of a regulatory artifact 140. The natural language generator 225 may then generate text for all or part of a regulatory submission based on the contextual data and the processed natural language. Each agent component 120 may provide its output to the regulatory artifact generation system 205. The regulatory artifact generation system 205 may then assemble the output into a regulatory artifact 140 or provide the output to another agent component 120 for further processing. For example, a single regulatory artifact 140 such as a labeling document may be generated by one or multiple agent components 120.

A product or service may require multiple regulatory artifacts 140. Each artifact may be generated by one or more agent components 120. The same agent component 120 may contribute to multiple regulatory artifacts 140, or separate agent components 120 may be assigned to each regulatory artifact 140. Each agent component 120 may be designed for a specific task. One agent component 120 may determine which template should be used for a regulatory artifact 140. Another agent component 120 may complete the template with data. A further agent component 120 may interact with the user 210 to obtain missing information. For example, a first set of user responses may indicate that certain templates are required, but additional data may be needed to complete them. An agent component 120 may be trained to prompt the user 210 for that missing data.

The feedback engine 125 in the system 200 acts as an interface between the regulatory artifact generation system 205 and one or more experts in the regulation. The feedback engine 125 collects feedback on the classification details 145 and the artifacts 140 and improves performance of the regulatory artifact generation system 205 and the agent component 120. The experts in medical device regulations and subject-matter specialists may be engaged to review the classification details 145 and the generated regulatory artifacts 140. Experts may assess whether the regulatory artifact generation system 205 has accurately classified the device and whether the documents generated by the agent component 120 meet the regulatory standards. Experts may provide feedback when they find any discrepancies, errors, or areas for improvement in the identified classification details 145 or the artifacts 140, they. The feedback provided by the experts is not only stored but also utilized by the regulatory artifact generation system 205 and the agent component 120 to refine their processes. In embodiments, the feedback engine 125 may achieve this using a reinforcement learning mechanism, which allows the system to improve its future performance by learning from the feedback on past outputs.

Referring to FIG. 3, FIG. 3 is an illustration of how the system 300 may create a knowledge base 115. The knowledge base 115 may be a storage repository for storing various types of interrelated data retrieved from multiple sources. The system retrieves data including the global regulations 155, the product standards 150, the real-world updates 160, and the proprietary data 165 from various sources such as regulatory authorities, international standard organizations, and other global organizations.

In embodiments, the global regulations 155 include regulatory standards and updated regulations from the regulatory authorities such as the U.S. Food and Drug Administration (FDA), European Medicines Agency (EMA), Health Canada, and the like. Product standards 150 may be implemented by various entities to verify that products or services meet safety and functional standards before they are introduced to the market. The product standards 150 for a medical device include medical device classification rules, risk assessment guidelines, and testing protocols defined by international bodies such as the International Organization for Standardization (ISO) and industry-specific regulatory frameworks.

The real-world updates 160 keep the knowledge base 115 relevant and updated as per the current regulatory landscape. The real-world updates 160 provide contextual information such as recent changes in regulatory frameworks, technological advancements, and updates from market reports, clinical trials, or new submissions.

The proprietary data 165 provides detailed insight into specific medical device categories, performance metrics, and market behavior. The proprietary data 165 includes expert knowledge, clinical trial results, and real-world regulatory submission data collected from professionals and organizations in the medical device industry.

In embodiments, the knowledge base 115 stores the interrelated data in the form of the knowledge graph 170 and the vector database 175. For instance, the system creates the knowledge graph 170 and the vector database 175 using the global regulations 155, the product standards 150, the real-world updates 160, and the proprietary data 165. The knowledge graph 170 is an interconnected structure that organizes and represents information as nodes and edges. Each node represents a data entity associated with one or more of the global regulations 155, the product standards 150, the real-world updates 160, and the proprietary data 165. Interconnections between the nodes form edges, representing how information represented by the nodes relate. In one example, a specific product standard node might be linked to a node representing FDA regulations, indicating that the product standard is influenced by or aligned with that regulatory body's requirements. In another example, when classifying a new medical device, the system can analyze the relationships between relevant regulatory standards, device classifications, and expert knowledge to recommend the most suitable regulatory pathway 135.

The vector database 175 complements the knowledge graph by storing unstructured and semi-structured data in a fast and efficient format. It uses vector representations to numerically encode data, enabling quick retrieval and comparison of large datasets. The vector database 175 stores documents related to the global regulations 155, the product standards 150, and the proprietary data 165 as vectors, which are numerical representations derived from natural language text. The vector database may retrieve large volumes of text-based data, relevant documents, and data points quickly. The combination of the knowledge graph 170 and the vector database 175 thus forms the knowledge base 115.

Before data from global regulations 155, product standards 150, real-world updates 160, and proprietary data 165 are loaded into the knowledge base 115, the system may perform data cleaning and hygiene operations to reduce the likelihood of propagating errors. The cleaning and hygiene operations may include removing duplicate entries, normalizing inconsistent formatting, and resolving conflicts between overlapping data sources. The data cleaning process may also validate the accuracy of incoming information, flag incomplete entries, and convert unstructured or semi-structured records into formats suitable for storage.

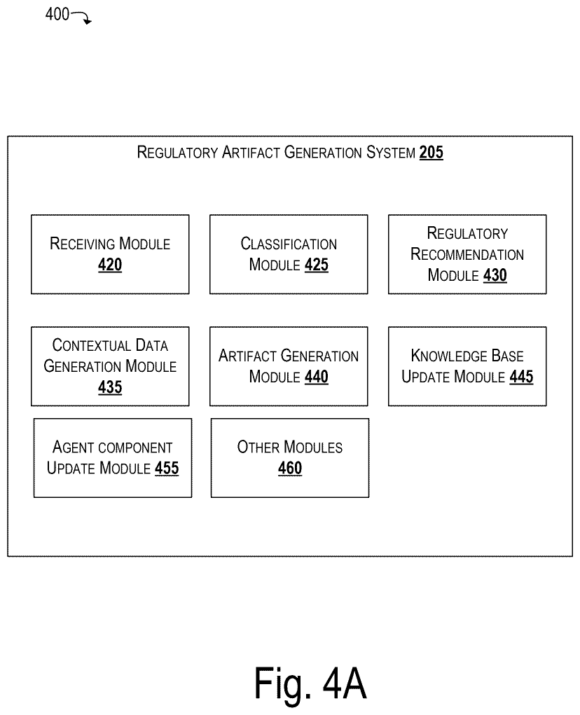

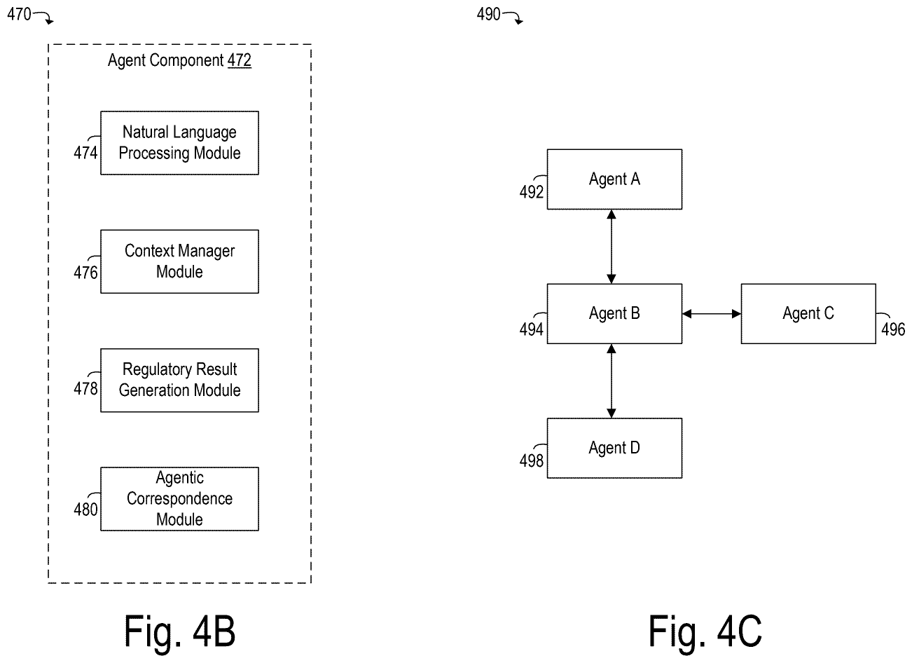

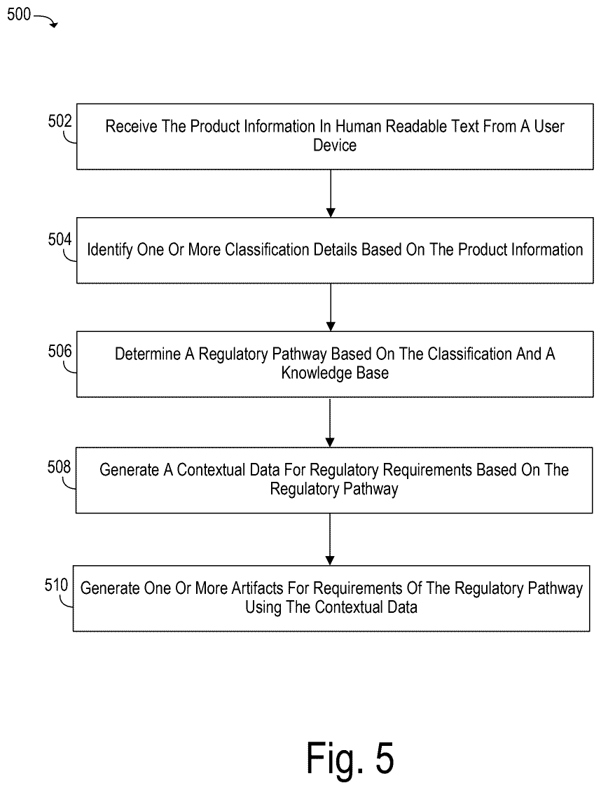

Referring to FIG. 4A, FIG. 4A is a schematic 400 illustrating an embodiment of the components of the regulatory artifact generation system 205. The regulatory artifact generation system 205 comprises one or more modules configured to generate artifacts 140 for regulatory submission of the medical device. The one or more modules include a receiving module 420, a classification module 425, a regulatory recommendation module 430, a contextual data generation module 435, an artifact generation module 440, a knowledge base update module 445, an agent component update module 455, and other modules 460. The one or more modules interact with each other via a network interface or a communication interface. In embodiments, an output generated by each module may be used by the one or more other modules to achieve an end result of artifact generation.

The receiving module 420 is configured to receive the product information 130 from the user 210, the user 210 can be a product manufacturer. The product information 130 describes the product or service for which the user 210 requires documents for regulatory submission. The receiving module 420 is further configured to receive responses to one or more questions prompted to the user 210 via the user device 110. For instance, the product may be a medical device and the product information 130 and the one or more questions are related to the medical device. The receiving module 420 receives the user input in human-readable text. The product information 130 may include essential details about the medical device.

The classification module 425 is configured to process the product information 130 received from the user 210 and identify the classification details 145 associated with the medical device. The classification module 425 analyzes the product standards 150 stored in the knowledge base 115 and identifies the classification details 145 of the medical device based on the product information 130. For example, the classification details 145 comprise a product code, risk classification, predicate devices, and the like.

The regulatory recommendation module 430 is configured to determine the regulatory pathway 135 for the medical device based on the classification details 145. The regulatory recommendation module 430 analyzes the classification details 145 identified by the classification module 425 and queries the knowledge base 115 to assess various global regulations 155, the product standards 150, and the proprietary data 165. The regulatory recommendation module 430 analyzes various interrelated data stored in the knowledge graph 170 and vector database 175 of the knowledge base 115. The regulatory recommendation module 430 determines the efficient and compliant regulatory pathway 135 for the medical device based on the analysis.

The contextual data generation module 435 is configured to generate the contextual data 180 reflecting specific regulatory requirements for the medical device, based on the regulatory pathway 135 determined by the regulatory recommendation module 430. This contextual data 180 is sourced from the knowledge base 115, which contains the updated global regulations 155, the real-world updates 160, and the proprietary data 165. For instance, the contextual data generation module 435 uses Artificial Intelligence techniques to generate the contextual data 180 customized to the specific regulatory pathway 135 determined for the medical device.

The artifact generation module 440 is configured to generate the artifacts 140 required for submission to the regulatory authorities for approval of the medical device. For example, the artifacts 140 include documents such as verification and validation documents, risk analysis and mitigation strategies, Labeling and Instructions for Use (IFU) documents, and the like. The artifact generation module 440 incorporates the agent component 120 and Artificial Intelligence (AI) techniques to generate the artifacts 140 required for the regulatory submission. The contextual data 180 is fed as an input to the agent component 120. The artifact generation module 440 uses Natural Language Processing (NLP) techniques to understand the contextual data 180 and generate human-readable and compliant documents using the agent component 120.

The artifact generation module 440 may incorporate one or more agent components 120 for generating regulatory artifacts 140. In some embodiments, the artifact generation module 440 may store a library of agent components 120, each configured for a different task. The artifact generation module 440 may select an appropriate agent component 120 based on the type of regulatory artifact 140 being generated. For example, one agent component 120 may be optimized for interpreting product information 130, while another agent component 120 may be optimized for drafting template-based regulatory text. The artifact generation module 440 may therefore utilize multiple agent components 120 in combination to produce a single regulatory artifact 140.

In some embodiments, the artifact generation module 440 may configure a sequence of agent components 120 to perform different steps of the artifact generation process. A first agent component 120 may determine which regulatory artifact 140 is required for a submission. Subsequent agent components 120 may then be selected to complete that artifact. In certain cases, the artifact generation module 440 may assign an agent component 120 with the specific task of establishing the sequence of other agent components 120 to be used. The artifact generation module 440 can coordinate multiple agent components 120 to generate complete and compliant regulatory artifacts 140 by sequencing tasks in this manner.

The knowledge base update module 445 is configured to dynamically update various data and their relationships in the knowledge base 115. The knowledge base update module 445 continuously integrates new information from global regulatory updates, market reports, and expert insights into the knowledge graph 170 and vector database 175. In embodiments, the knowledge base update module 445 updates the relationships between the nodes in the knowledge graph 170 based on the real-world updates 160.

The agent component update module 455 is configured to refine the performance of the agent component 120 based on feedback provided by regulatory experts. Upon generation of the regulatory artifacts 140 by the artifact generation module 440, these artifacts 140 are reviewed by experts for accuracy and quality. The feedback from the experts is analyzed by the agent component update module 455, which may use a reinforcement learning mechanism to improve the agent component's 120 future performance.

The agent component update module 455 may be configured to identify specific agent components 120 for refinement when multiple agent components 120 are used within the regulatory artifact generation system 205. For example, if the user 210 determines that a particular section of a regulatory artifact 140 requires improvement, the agent component update module 455 may trace the section back to the one or more agent components 120 that generated it. The agent component update module 455 may then isolate those agent components 120 for modification while leaving other agent components 120 unchanged.

The agent component update module 455 may improve agent components 120 through a variety of mechanisms. In one embodiment, the agent component update module 455 may apply reinforcement learning methods that incorporate user or expert feedback into the behavior of the agent components 120. The agent component update module 455 may also integrate new contextual data 180 or regulatory updates from the knowledge base 115 into the training process.

Referring to FIG. 4B, FIG. 4B is a schematic 470 of an embodiment of the agent component 472. The agent component 472 may be configured to process contextual input and generate outputs that may be assembled into regulatory artifacts 140. The agent component 472 may be used alone or in combination with other agent components 472 to generate a single regulatory artifact 140. The agent component 472 may also interact with the knowledge base 115 to extract relevant contextual data 180 required for a given task. In some cases, the agent component 472 may be configured to communicate with other agent components 472 to divide tasks and coordinate outputs.

In the embodiment shown in FIG. 4B, the agent component 472 comprises a natural language processing module 474, a context manager module 476, a regulatory result generation module 478, and an agentic correspondence module 480. The modules may operate so that the agent component 472 can receive inputs, interpret the inputs, identify the appropriate context, generate outputs, and coordinate with other agent components 472 when needed.

The natural language processing module 474 interprets inputs provided to the agent component 472. The input may originate from another part of the system 100, from the knowledge base 115, or from a user 210. The natural language processing module 474 may interpret a natural language query used to extract information from the knowledge base 115. The natural language processing module 474 may also interpret a user response to a prompt presented by the system 100. In some cases, the natural language processing module 474 may interpret the structure of a regulatory template to determine how the template should be completed.

The context manager module 476 manages the context for a given task. The context manager module 476 may query the knowledge base 115 to retrieve relevant contextual data 180. The context manager module 476 may determine which context is required based on the task assigned to the agent component 472. In some embodiments, the context manager module 476 may be provided with specific contextual data 180 by another part of the system 100. In other embodiments, the context manager module 476 may independently determine what context is needed and request the data from one or more system components.

The regulatory result generation module 478 creates the output of the agent component 472. After an input is interpreted by the natural language processing module 474 and the relevant context is identified by the context manager module 476, the regulatory result generation module 478 generates an output. Examples of the output may be a retrieved context, a user prompt, a template for a regulatory artifact 140, or a completed regulatory artifact 140. For example, the regulatory result generation module 478 may generate a user prompt and accompanying instructions, or it may generate an entire regulatory submission document populated with product information 130 and classification details 145.

The agentic correspondence module 480 enables the agent component 472 to coordinate with other agent components 472. Some tasks may require a sequence of agent components 472 working together. For example, one agent component 472 may interact with the user 210, another agent component 472 may classify the product, another may generate a template, and another may complete the template. In this case, the agentic correspondence module 480 facilitates communication between the agent components 472.

One agent component 472 may provide context to another agent component 472 that specializes in filling in portions of a regulatory artifact 140. In some embodiments, an agent component 472 may divide a regulatory artifact 140 into separate portions, direct each portion to a specialized agent component 472, and coordinate the assembly of the complete artifact. The agentic correspondence module 480 may provide a natural language prompt, contextual data, a template, or anything else that a first agent component may provide to a subsequent agent component so that it may complete the task.

Referring to FIG. 4C, FIG. 4C is a schematic 490 showing how multiple agent components may be configured to work together to produce a regulatory artifact 140. In the example shown, Agent A 492, Agent B 494, Agent C 496, and Agent D 498 each perform different tasks that contribute to the generation and organization of a regulatory artifact 140. Each agent may receive contextual data 180 from the system 100 and may correspond with other agents through their agentic correspondence modules 480.

The example below illustrates how multiple agent components 120 may divide tasks, correspond with each other, and produce outputs that are assembled into a complete regulatory submission. Each agent may be specialized for a particular role, such as template selection, context management, section completion, or final assembly.

Agent A 492 may be tasked with determining the correct template for a regulatory artifact 140. For example, the system 100 may provide a prompt directing Agent A 492 to determine the appropriate template for a medical device classification. A device that measures blood oxygen and provides an alert when the blood oxygen level changes may serve as an example. Agent A 492 may determine the classification for that device and select a template that corresponds to the classification. The output of Agent A 492 may then be provided to other agents along with the context that supports the selection of the template.

Agent B 494 may receive the template identified by Agent A 492 and interpret it as a whole. Agent B 494 may determine which sections of the template must be completed first. The template may be incomplete but structured in a way that enables Agent B 494 to identify the context required for each section. Agent B 494 may review the first section, determine what context is needed, and prepare a prompt and supporting context for another agent to complete that section. The regulatory result generation module 478 of Agent B 494 may generate the prompt, and the agentic correspondence module 480 of Agent B 494 may provide the prompt and context to Agent C 496.

Agent C 496 may receive the prompt and context from Agent B 494. Agent C 496 may generate the output needed to fill in the section of the template and return that output to Agent B 494. Agent B 494 may then proceed to the next section of the template, identify the context needed, and again generate a prompt for Agent C 496. Agent C 496 may complete that section in the same manner. This process may continue until all sections of the template have been filled. Agent B 494 may then assemble the completed template and generate a completed regulatory artifact 140.

The completed regulatory artifact 140 may then be provided to Agent D 498. Agent D 498 may be tasked with organizing the completed regulatory artifact 140 into a larger submission. For example, Agent D 498 may receive a prompt to determine how the artifact fits into a broader set of related regulatory artifacts. Agent D 498 may classify the artifact within the submission and assemble it with other regulatory artifacts to create a complete regulatory submission package.

The agent components 120 can be deployed on a range of hardware configurations. In some cases, the agent components 120 are located on the same computer system and communicate directly through system memory or a local bus. In other cases the agent components 120 are distributed across separate computer systems and communicate through wired network connections. Wireless connections may also be used, allowing the agent components 120 to exchange messages across different devices and physical locations. The disclosed system therefore supports both integrated and distributed hardware arrangements.

Each agent component 120 may have its own storage medium for contextual data. In some cases the storage used by one agent component 120 is not accessible to other agent components 120. In other cases multiple agent components 120 share access to the same contextual data and coordinate their processing. The design choice affects how each agent component 120 operates, as the scope of data available to it can limit or expand the tasks it can perform. Separate storage can be used to enforce boundaries between different regulatory functions or to restrict access to sensitive information.

Communication between agent components 120 can also be configured in one-way or two-way patterns. One agent component 120 may be set to transmit data to another without receiving any response. Another agent component 120 may be configured for full duplex communication, sending and receiving data as needed. The direction of communication shapes how each agent component 120 interacts with contextual data and determines what type of output it can generate. By combining one-way and two-way communication links, the system controls the flow of information and constrains how the agent components 120 act within the larger architecture.

The system may further include an orchestrating agent that manages the operation of multiple agent components. The orchestrating agent may not only direct other agent components but may also select which agent components are used for a particular task. The orchestrating agent may identify a sequence of agent components to process a task and may assign each agent component to perform a portion of the task. In some embodiments, the orchestrating agent may determine which agent components to select or orchestrate based on the classification of the task.

The orchestrating agent may also review the work of other agent components during execution. For example, the orchestrating agent may review an output of an agent component in a sequence and adjust the sequence based on that output. The orchestrating agent may further alter one or more task prompts for subsequent agent components in the sequence in response to an intermediate output. In this way, the orchestrating agent can make adjustments on-the-fly to improve the accuracy and efficiency of the overall process.

In an example of the orchestrating agent modifying a task based on an intermediate output, a first agent component in the sequence may output a template that requires N regulatory artifacts. Each of the n regulatory artifacts may require a sub-sequence of agent components to generate. Accordingly, the orchestrating agent may make further modifications to the sub-sequence as each regulatory artifact is generated. For instance, a first agent component in the sub-sequence may generate a template for the regulatory artifact. The template may contain M sections to complete. Accordingly, the orchestrating agent may generate a sequence of agent components to complete the various sections of the template.

The orchestrating agent may also determine communication patterns between agent components that process a task. For example, the orchestrating agent may dynamically adjust which data stores are available to specific agent components. In various embodiments, the orchestrating agent may also dynamically connect hardware that represents different agent components and data stores. For instance, the orchestrating agent may connect one or more network nodes to one or more agent components and then connect those network nodes to data stores. The network nodes may further connect different agent components to each other.

The various arrows connecting the agent components in FIG. 4C may comprise network nodes. A network node may be implemented as hardware, software, or a combination of both. A network node may comprise a processor, memory, and a network interface configured to transmit or receive data. A network node may also represent a virtualized resource in a cloud environment or a physical device in a local system. In various embodiments, the network node may act as an intermediary that manages data transfer between agent components and data stores, or as a direct connection point between different agent components.

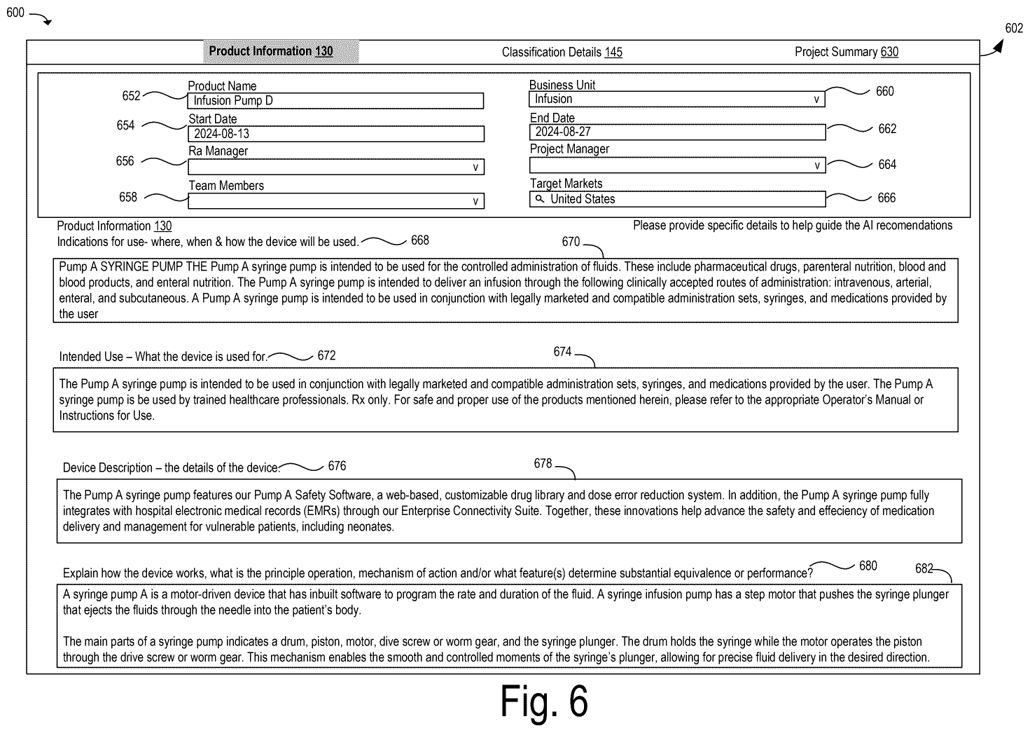

Referring to FIG. 5, FIG. 5 is a flow diagram of a process for generating regulatory artifacts. The process of the flow diagram 500 may be implemented to generate regulatory recommendations for a product to be submitted for regulatory approval. For instance, the regulatory recommendations may include a regulatory pathway and the regulatory artifact.

At step 502 of the flow diagram 500, the process receives a product information in human readable text from a user. The step 502 provides the user with a prompt to input the product information via the user device 110. The product information describes the product or service for which the user requires documents for the regulatory submission. For example, the product may be a medical device and the product information may be the medical device description provided by the user.

At step 504, the process identifies one or more classification details based on the product information. The process analyzes the product information provided by the user and identifies the classification details 145 using the knowledge base 115 comprising the product standards 150 of various medical devices. The one or more classification details for the medical device may include a product code, risk classification, predicate devices, and other classification details as defined by the regulatory authorities.

At step 506, the process determines the regulatory pathway based on the classification details 145 and the knowledge base 115. The process analyzes the classification details 145 and queries the knowledge base 115 which comprises interrelated information, including global regulations 155, the proprietary data 165, and the real-world updates 160, from various sources using one or more agent components 120. Embodiments of the agent components 120 can analyze interrelated information using the knowledge graph 170 and the vector database 175 and determine an optimal regulatory pathway 135 for the medical device.

At step 508, the process generates a contextual data for regulatory requirements based on the regulatory pathway. For instance, the process retrieves specific guidelines or submission requirements from the vector database 175 and generates the contextual data that reflects the regulatory requirements for the medical device. The contextual data is generated using artificial intelligence techniques and the contextual data is customized as per the determined regulatory pathway.

At step 510, the process generates one or more artifacts for requirements of the regulatory pathway using the contextual data. The process may analyze the requirements for the regulatory pathway and generate the one or more artifacts compliant with the regulatory pathway using the agent component 120. For example, the one or more artifacts may include set of documents required for submitting to the regulatory authorities for the medical device approval. The agent component 120 may generate the artifacts using the contextual data as a basis for the generation.

In various embodiments, the process may select a template based on the product information. For example, the template may be selected by a classification algorithm. The template may then serve as a structure for the agent component 120 to generate the regulatory artifacts.

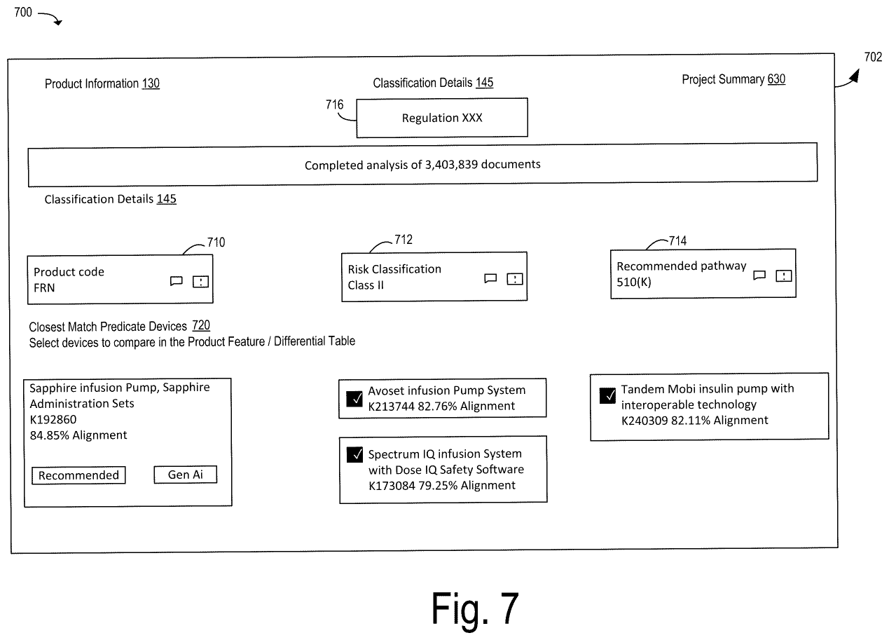

Referring to FIGS. 6-10, FIGS. 6-10 comprise screenshots displaying various outputs of the disclosed subject matter. The screenshots show embodiments that are not meant to limit the layout and context of output on a display of the disclosed subject matter, but to show an example of one of many possible embodiments of a screenshot output.

Referring to FIG. 6, FIG. 6 is an illustration of a screenshot 600 of an embodiment of the disclosed subject matter. The screenshot 600 shows an example of a user input screen 602 that prompts a user to enter various information about a product or service, for which the disclosed subject matter may provide submission documents or other submission materials. The product input screen 602 may allow the disclosed subject matter to produce all submission materials. In various embodiments, additional prompts or feedback may be needed to produce the submission materials. The disclosed subject matter may further prompt the user for additional information based on the response or answers provided in the screenshot 600. In an example of use, the screenshot 600 prompts the user to enter various metadata associated with the product or service, as well as prompting the user to enter freeform answers to one or more questions related to the product or service.

The disclosed user input screen 602 shown in the screenshot 600 includes a section on top that prompts a user to enter metadata associated with the product or service. The screenshot 600 includes three parts: Product Information 130, Classification Details 145, and Project Summary 630. The section at the bottom of the screenshot 600 prompts a user to enter freeform answers based on questions associated with the product or service in the Product Information 130 section. Examples of the metadata shown in the screenshot 600 include a product name 652, a start date 654, an RA manager 656, team members 658, a business unit 660, an end date 662, a project manager 664, and target markets 666.

The bottom of the screenshot 600 includes questions that prompt a user to enter free-form answers related to a product or service. The free-form answers may be processed by the disclosed subject matter to determine rules, regulations, laws, and the like that apply to the product or service being disclosed. The answers, including the metadata, may also allow the disclosed subject matter to produce submittable documents or similar materials for the user.

The answers to the user prompts may be provided by the user in natural language. In the embodiment shown in the screenshot 600, the user is prompted to type the answer in sentence form. The user may enter one or more sentences to answer the prompt. For example, the first prompt 668 asks the user to provide indications for use, where, when, and how the device will be used. The user may then answer the question in the best way that they can be in natural language in the provided text box 670.

In embodiments, the system may be configured to receive answers to the prompts in formats other than text. For example, a user may be prompted to answer the prompt by speaking the answer in natural language. In another embodiment, the answer may be provided on a handwritten document. For example, a user may be provided with a single-page document with one or more user prompts. A user may then handwrite or type answers to the prompts on the piece of paper, which are then processed by the disclosed subject matter. In an example of use, the handwritten document may be scanned by an imaging device and processed for natural language.

The metadata and freeform answers provided by the user on the user input screen 602 are all forms of the product information 130 that are provided to the AI processing engine 105. The product information 130 may be processed by the knowledge base 115 to determine the contextual data 180 for the product or service.

A second user prompt 672 prompts a user to input a free-form answer for a product or service's intended use, what the device is used for. The user may input one or more sentences describing the intended use of the product or service in unlimited detail. Like the first user prompt, a textbox 674 is provided for the user to enter the answer to the second user prompt.

The user input screen 602 may include any number of user prompts that allow a user to provide free-form answers to the prompted question. The number of user prompts may vary based on the information typically provided as answers to the prompt. In an exemplary embodiment, the number of user prompts is determined by the number of prompts that typically explain the product information 130 to determine a context sufficient to provide satisfactory submission documents and other materials for the user. In an example of use, additional prompts may be provided to the user where the user's answers do not provide enough information to produce a context sufficient to complete submission documents or other material.

The third user prompt 676 prompts the user to enter a device description-the details of the device. The user input screen 602 provides a text box 678 to encourage a user to write the free-form answer to the prompted question. The size of the text box 678 may encourage a user to enter an ideal amount of text. For example, the text box 678 provides approximately five lines of space. The user may be encouraged to enter two to four lines of information. Accordingly, the size of the text box may be configured to subtly communicate to the user the amount of freeform information to answer the user prompt.

The fourth user prompt 680 asks the user to provide an answer to the following prompt: Explain how the device works, what is the principal operation, mechanism of action, and/or what features determine substantial equivalence or performance. The provided text box 682 prompts the user to answer the fourth user prompt in natural language in the text box. As in the example shown in the screenshot 600, the user prompts may request that the user provide highly detailed information. For example, the fourth user prompt 680 may request the user to provide details about how a potentially complex device works. In various embodiments, the product or service may be highly complex or have any level of complexity.

Agent components 120 may be configured to process the user input provided through the prompts shown in FIG. 6. In some embodiments, one agent component 120 may interpret the responses and retrieve relevant context from the knowledge base 115 or the knowledge graph 170. Another agent component 120 may use that context together with the user input to classify the product or service. The classification may include identifying the regulatory category, the applicable standards, and any predicate devices that may be relevant.

Additional agent components 120 may then build on the classification. One agent component 120 may determine the appropriate template to be used for generating a regulatory artifact 140. Another agent component 120 may complete the template using the user responses and the contextual data 180. The resulting regulatory artifact 140 may therefore incorporate both user input and knowledge base information.

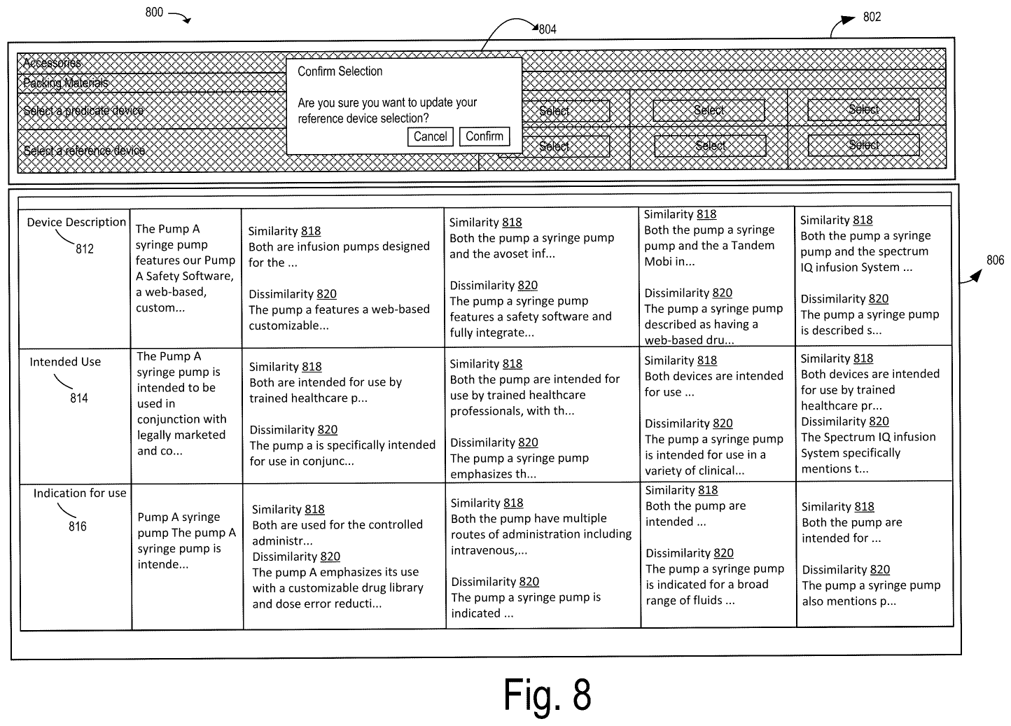

Referring to FIG. 7, FIG. 7 is a screenshot illustrating generation of classification details in an embodiment of the disclosed subject matter. Classification Details 145 may refer to a classification number system that is often associated with products or services that are being regulated. For example, in certain categories of regulation and certain industries, every product has a specific classification. For instance, the classification may be based on a product type, or the classification may also be based on the purpose of the product. The classification may be based on an industry for which the product exists. The classification may be based on other details related to a product or service.

The disclosed subject matter is configured to determine the classification of the product or service where a classification is appropriate. The screenshot shows a Classification Details 145 tab of a user interface of the disclosed subject matter. The Classification Details 145 tab includes an output of a classification analysis provided by the disclosed system.

The output of the classification analysis may include various classification details. For example, the screenshot shows a product code 710, a risk classification 712, and a recommended pathway 714. In embodiments, multiple classifications may be provided to the user, allowing the user to select one of the multiple classifications provided. For example, where multiple classifications may be appropriate, the system may be configured to provide each of the appropriate classifications to the user. In various examples, some classifications may be ambiguous as to which is appropriate, and the system may be configured to provide each of the closest classifications to the user and allow them to pick the best one based on their knowledge and experience. In embodiments, the system may be further configured to provide one or more closest match predicate devices 720.

A predicate device may be a product or service that already exists and is legally marketed. In various markets, such as the medical device industry, a predicate device is an existing, legally marketed device that can be compared to the new device by demonstrating substantial equivalence. This may allow the new device to enter the market with fewer regulatory hurdles. Determining and finding a predicate device may be a difficult process. The system is configured to both classify and determine a predicate device, if one exists, based on the description provided by the user in the user input screen 602.

The system may also be updated with information regarding the most recently released products. Accordingly, the system may identify predicate devices that a human reviewer may not yet be aware of because of the recency of their release.

In the example shown in FIG. 7, the user interface 702 may further include an applicable regulation field 716. The regulation field 716 may identify one or more regulations that apply to the subject device based on the classification details 145 and the recommended pathway 714. In some embodiments, the regulation field 716 may display a specific regulation, such as a section of a medical device regulation, or may display a generic placeholder for later completion by a user.

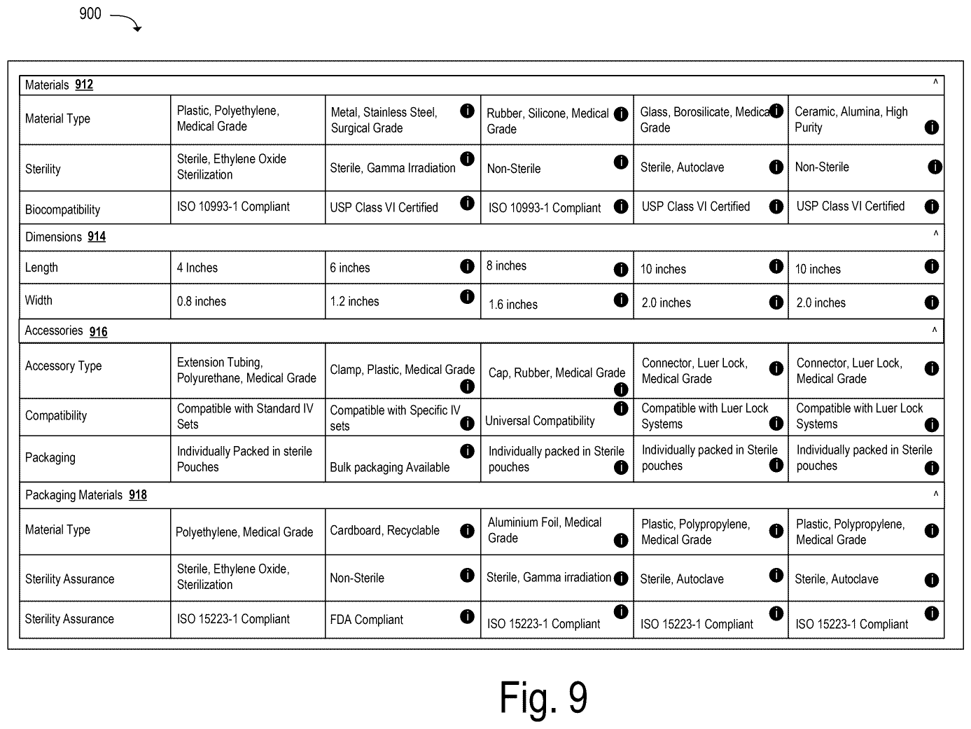

Referring to FIG. 8 and FIG. 9, FIG. 8 is a screenshot 800 illustrating generation of a comparative analysis of a reference product and selected predicate devices in an embodiment of the disclosed subject matter. FIG. 9 is a screenshot 900 illustrating generation of product details of selected predicate devices in an embodiment of the disclosed subject matter. In some embodiments, the disclosed subject matter may provide the user with one or more predicate devices. The predicate devices may be similar devices that are already being sold on the market. In some cases, regulations may allow a user to select a predicate device to avoid some regulatory hurdles. However, the selection of the predicate device is an important decision and difficult because no two devices are exactly the same, and the definition of an equivalent may not be clear-cut. Accordingly, the disclosed subject matter may provide additional details on the predicate devices to aid the user in the decision of which predicate device to select. As shown in the screenshot 800, the disclosed subject matter may provide various descriptions of predicate devices, including similarities and dissimilarities for various predicate devices.

The screenshot 800 displays a selection box 802, allowing a user to select various predicate devices. Upon selecting the predicate devices, a confirm selection window 804 is displayed to the user to confirm the selection of predicate devices. Below the selection box 802 is a comparison array 806 that displays similarities 818 and dissimilarities 820 of various criteria between the predicate device and the device described by the user. A user may be able to quickly consult the similarities 818 and dissimilarities 820 of various predicate devices to determine the best selection for a predicate device, if one is able to identify the difference between the predicate device and the device described by the user.

As shown in the screenshot 800, similarities 818 and dissimilarities 820 are displayed for various criteria for the different predicate devices. The criteria include device description 812, intended use 814, and indication for use 816. Further, a definition of each criterion is provided in addition to the selected criteria. In an exemplary embodiment, each of the similarities 818 and dissimilarities 820 is generated by the disclosed subject matter based on a context provided by the knowledge base. In the example shown in the screenshot 800, the definitions for each of the criteria are also generated by the disclosed subject matter.

The screenshot 900 shows further details of the various predicate devices. As shown in the screenshot 900, the further details include materials 912, dimensions 914, accessories 916, and packaging materials 918. Details in the materials 912 are further refined by material type, sterility, and biocompatibility. The dimensions 914 are defined by length and width. The accessories 916 are further defined by accessory type, compatibility, and packaging. The packaging materials 918 are further refined by material type, sterility assurance, and labeling. Accordingly, a user may consult the screenshot 900 to determine additional details for predicate devices.

FIGS. 8 and 9 illustrate a process for identifying predicate devices that requires less manual review and supports more frequent evaluation than contemporary methods, which often involve time-consuming reviews of prior submissions, regulatory databases, and industry records. Contemporary methods can be slow, expensive, and difficult to repeat when testing multiple device designs. The disclosed system retrieves contextual data, aligns device attributes, and generates structured comparisons in real time. The result is a process that requires less manual review and operates at a speed that supports more frequent evaluation.

The disclosed system also makes it possible to evaluate several device configurations in quick succession. Users can test variations, compare them against regulatory requirements, and review outcomes without repeating the entire manual process. Accordingly, the disclosed system potentially reduces costs, errors, and opens up new ways that its users and entities can ideate new products and services.

In some embodiments, the content displayed in the screenshots of FIG. 8 and FIG. 9 is dynamically generated based on the type of device being evaluated. If a category of information is not applicable to the device, the corresponding section is not displayed. For example, when the device under review is software of a medical device, sections relating to materials or dimensions may be omitted.

In addition, the screenshots may include icons that indicate similarities between the subject device and predicate devices. The visual indicators give the user a quick reference to identify which criteria align and which criteria diverge.

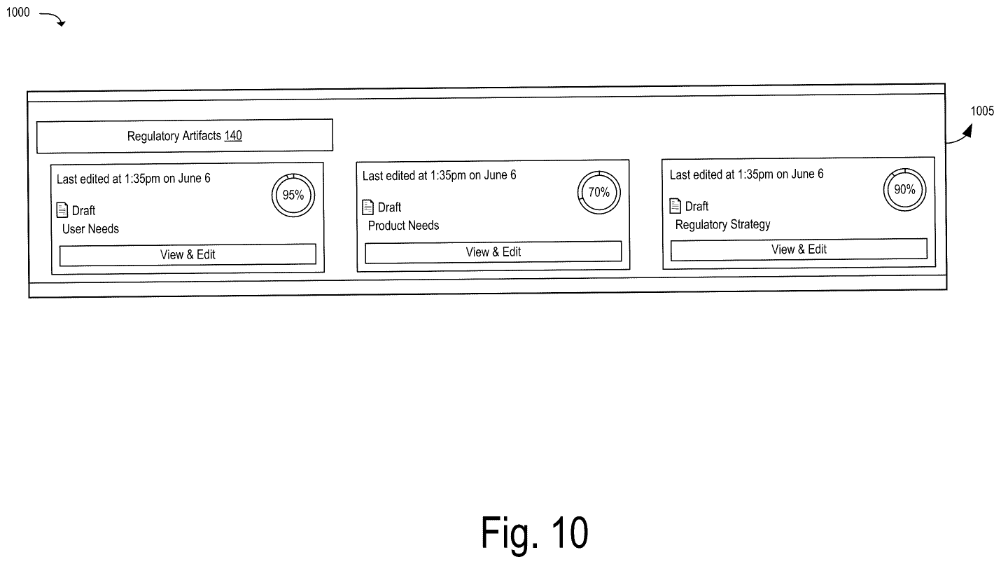

Referring to FIG. 10, FIG. 10 is a screenshot 1000 illustrating regulatory artifacts generated by the regulatory artifact generation system. As shown in the screenshot 1000, the user may be provided with a set of one or more regulatory artifacts 140 prepared for the user. The user may be provided with user interface buttons to view and edit the various regulatory artifacts 140. The regulatory artifacts 140 may refer to regulatory documents, submission materials, compliance documentation, regulatory reports, approval documentation, compliance files, regulatory filings, regulatory submissions, authorization paperwork, regulatory dossiers, or the like.

The disclosed subject matter may determine which regulatory artifacts are appropriate based on the description of the product or service provided by the user. In the example shown in the screenshot 1000, the user is provided with regulatory artifacts for user needs, product needs, and regulatory strategy. The user is given the opportunity to view and edit each of the prepared regulatory artifacts.

In an example, the system determines a context based on the answers from the user prompts and provides the context to one or more agent components. The one or more agent components then completes or fills out a template that is selected by the disclosed subject matter.

In some embodiments, the template may be selected using a machine learning algorithm, such as a decision tree or random forest. Each completed template may be provided to the user as a regulatory artifact. The term template, as used herein, may be a structured document or other document. The system may also enable the user to edit these regulatory artifacts to suit specific needs or make modifications as necessary.

The regulatory artifacts shown in FIG. 10 represent examples of the types of documents that may be generated by the disclosed system. In practice, the system is capable of producing many more regulatory artifacts than those illustrated. For a single product or device, the system may generate tens or even hundreds of regulatory artifacts. The actual number and type of regulatory artifacts may vary depending on the classification of the device, the applicable regulatory pathway, and the jurisdictions in which approval is sought.

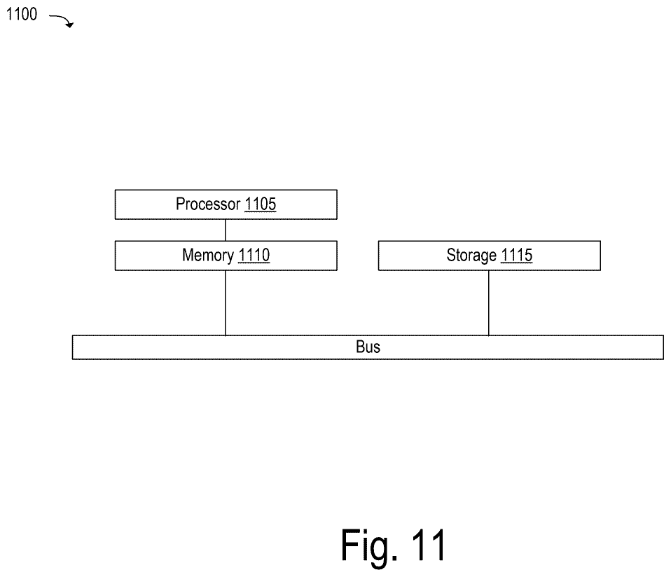

Referring to FIG. 11, FIG. 11 is a schematic of a computer system 1100 that may be implemented to perform various processes in the disclosed subject matter. The computer system 1100 may be a single computer system, multiple computer systems, a co-located computer system, a virtual machine, a cloud-based system, or any combination thereof. The computer system 1100 may provide various processes for a user to interact with the disclosed subject matter. The computer system 1100 may present one or more processes of the server that provide the user with regulatory artifacts. The computer system 1100 may provide interactive functions with the user when the user inputs answers to the user prompts and metadata prompts. The computer system 1100 may also store data in the storage 1115.

The processor 1105 may perform operations and process instructions provided to it by the memory 1110. Instructions may be passed back to the memory 1110 and then passed to one or more components of the computer system 1100. The processor 1105 may include central processing units (CPUs), graphics processing units (GPUs), field-programmable gate arrays (FPGAs), complex programmable logic devices (CPLDs), and application-specific integrated circuits (ASICs). The memory 1110 may include examples such as random-access memory (RAM) and read-only memory (ROM). Data may be stored in the storage 1115, which may include examples of spinning hard drives and solid-state storage.

The disclosed subject matter includes methods, systems, and computer-readable storage medium for generating regulatory artifacts. The method involves receiving a product information in human-readable text from a user device and identifying one or more classification details based on the product information. Further, the method includes determining a regulatory pathway based on the classification and a knowledge base, the knowledge base comprising interrelated regulatory data. The method further includes generating a contextual data for regulatory requirements from the knowledge base based on the regulatory pathway and generating, by one or more agent components, one or more artifacts for requirements of the regulatory pathway. The system comprises a memory and a processor configured to execute instructions to perform the steps above, thereby automating regulatory artifact generation for the product.

A method for generating regulatory artifact includes receiving from a user device, a product information in human-readable text. The method includes identifying, by a classification module, one or more classification details based on the product information. The method further includes determining, by a regulatory recommendation module, a regulatory pathway based on the one or more classification details and a knowledge base, the knowledge base including regulatory data. The method includes generating, by a contextual data generation module, a contextual data for regulatory requirements from the knowledge base based on the regulatory pathway. The method further includes generating, by one or more agent components, one or more artifacts for requirements of the regulatory pathway using the contextual data. The method may include product information that describes a medical device. The method may include classification details that comprise a predicate device. The method may include a knowledge base that comprises a knowledge graph and a vector database. The one or more agent components may be configured to process the human-readable text from the user to generate the product information. The method may include generating the one or more artifacts by two or more agent components that operate in a sequence to generate at least one of the artifacts. The method may include updating the regulatory pathway and updating connections between one or more nodes in the knowledge graph based on the updated regulatory pathway. The method may include improving a performance of at least one of the one or more agent components based on feedback, the feedback responsive to the artifacts. The method may include one or more agent components that comprise natural language processing and natural language generation to interpret regulatory guidelines for generating compliant, human-readable text for the artifacts. The method may include a plurality of agent components comprising a sequence of agent components that are configured to work together to generate the artifacts. The sequence of agent components may be directed by one or more orchestrating agent components. The method may include identifying, using a traceability matrix, an input source of a modification in the artifacts.

An exemplary embodiment is, a computer system that includes a processor and a memory to store computer-executable instructions that, if executed, cause the processor to receive from a user, product information in human-readable text. The processor is configured to identify one or more classification details based on the product information. The processor is configured to determine a regulatory pathway based on the classification and a knowledge base, the knowledge base including interrelated regulatory data. The processor is configured to generate a contextual data for regulatory requirements from the knowledge base based on the regulatory pathway. The processor is further configured to generate, by one or more agent components, one or more artifacts for requirements of the regulatory pathway using the contextual data. The computer system may include product information that describes a medical device and classification details that comprise a predicate device. The computer system may include a knowledge base that comprises a knowledge graph and a vector database, wherein the knowledge graph comprises one or more nodes representing regulations. The computer system may include updating the regulatory pathway and updating connections between the one or more nodes in the knowledge graph based on the updated regulatory pathway. The computer system may include generating the one or more artifacts by two or more agent components that operate in a sequence to generate at least one of the artifacts. The processor may be further configured to improve a performance of at least one of the agent components based on feedback, the feedback responsive to the artifacts. The computer system may include one or more agent components that comprise natural language processing and natural language generation to interpret regulatory guidelines for generating compliant, human-readable text for the artifacts. The computer system may include a plurality of agent components comprising a sequence of agent components that are configured to work together to generate the artifacts.

Another general aspect is, a computer readable storage medium having data stored therein representing software executable by a computer system, the software including instructions that, when executed, cause the computer readable storage medium to perform receiving from a user, product information in human-readable text. The software further includes identifying one or more classification details based on the product information. The software includes determining a regulatory pathway based on the classification details and a knowledge base, the knowledge base including interrelated regulatory data. The software further includes generating a contextual data for regulatory requirements from the knowledge base based on the regulatory pathway. The software includes generating, by one or more agent components, one or more artifacts for requirements of the regulatory pathway using the contextual data.

Many variations may be made to the embodiments described herein. All variations, including combinations of embodiments, are intended to be included within the scope of this disclosure. The description of the embodiments herein can be practiced in many ways. Any terminology used herein should not be construed as restricting the features or aspects of the disclosed subject matter. The scope should instead be construed in accordance with the appended claims.

1. A method for generating regulatory artifact, the method comprising:
receiving from a user device, a product information in human-readable text;
identifying, by a classification module one or more classification details based on the product information;
determining, by a regulatory recommendation module, a regulatory pathway based on the one or more classification details and a knowledge base, the knowledge base comprising regulatory data;
generating, by a contextual data generation module, a contextual data for regulatory requirements from the knowledge base based on the regulatory pathway; and
generating, by one or more agent components, one or more artifacts for requirements of the regulatory pathway using the contextual data.

2. The method of claim 1, wherein a first one of the one or more agent components are configured to process the contextual data; and
wherein a second one of the one or more agent components is configured to generate at least one of the one or more artifacts based on the generated contextual data.

3. The method of claim 1, wherein the one or more classification details comprise a predicate device.

4. The method of claim 1, wherein the knowledge base comprises a knowledge graph and a vector database.

5. The method of claim 1, wherein generating the one or more artifacts comprises two or more agent components that operate in a sequence to generate at least one of the one or more artifacts.

6. The method of claim 1, wherein in the one or more agent components are configured to process the human-readable text from the user to generate the product information.

7. The method of claim 1, further comprising improving a performance of at least one of the one or more agent components based on feedback, the feedback responsive to the one or more artifacts.

8. The method of claim 1, wherein each of the one or more agent components comprises natural language processing (NLP) and natural language generation (NLG) to interpret regulatory guidelines for generating compliant, human-readable text for the one or more artifacts.

9. The method of claim 1, wherein the one or more agents components comprise a plurality of agent components, the plurality of agent components comprising a sequence of agent components that are configured to work together to generate the one or more artifacts.

10. The method of claim 9, wherein the sequence of agent components are directed by one or more orchestrating agent components.

11. The method of claim 1, further comprising identifying, using a traceability matrix, an input source of a modification in the one or more artifacts.

12. A computer system, comprising:
a processor; and
a memory to store computer-executable instructions that, if executed, cause the processor to:
receive from a user, product information in human-readable text;
identify one or more classification details based on the product information;
determine a regulatory pathway based on the classification and a knowledge base, the knowledge base comprising interrelated regulatory data;
generate a contextual data for regulatory requirements from the knowledge base based on the regulatory pathway; and
generate, by one or more agent components, one or more artifacts for requirements of the regulatory pathway using the contextual data.

13. The computer system of claim 12, wherein the product information describes a medical device; and
wherein the one or more classification details comprise a predicate device.

14. The computer system of claim 12, wherein the knowledge base comprises a knowledge graph and a vector database, the knowledge graph comprises one or more nodes representing regulations.

15. The computer system of claim 14, further comprising updating the regulatory pathway; and
updating connections between the one or more nodes in the knowledge graph based on the updated regulatory pathway.

16. The computer system of claim 12, wherein generating the one or more artifacts comprises two or more agent components that operate in a sequence to generate at least one of the one or more artifacts.

17. The computer system of claim 12, wherein the processor is further configured to improve a performance of at least one of the one or more agent components based on feedback, the feedback responsive to the one or more artifacts.

18. The computer system of claim 12, wherein each of the one or more agent components comprises natural language processing (NLP) and natural language generation (NLG) to interpret regulatory guidelines for generating compliant, human-readable text for the one or more artifacts.

19. The computer system of claim 12, wherein the one or more agents components comprise a plurality of agent components, the plurality of agent components comprising a sequence of agent components that are configured to work together to generate the one or more artifacts.

20. A computer readable storage medium having data stored therein representing software executable by a computer system, the software comprising instructions that, when executed, cause the computer readable storage medium to perform:
receiving from a user, product information in human-readable text;
identifying one or more classification details based on the product information;
determining a regulatory pathway based on the one or more classification details and a knowledge base, the knowledge base comprising interrelated regulatory data;
generating a contextual data for regulatory requirements from the knowledge base based on the regulatory pathway; and
generating, by one or more agent components, one or more artifacts for requirements of the regulatory pathway using the contextual data.
